(19) United States
(12) Patent Application Publication
(10) Pub. No.: US 2014/0078186 A1
(43) Pub. Date: Mar. 20, 2014

(54) Array Substrate and Liquid Crystal Display

(71) Applicants: Cheng-hung Chen, Shenzhen City (CN); Zui Wang, Shenzhen City (CN)

(72) Inventors: Cheng-hung Chen, Shenzhen City (CN); Zui Wang, Shenzhen City (CN)

(73) Assignee: SHENZHEN CHINA STAR OPTOELECTRONICS TECHNOLOGY CO., LTD., Shenzhen, Guangdong (CN)

(21) Appl. No.: 13/642,548

(22) PCT Filed: Sep. 25, 2012
(86) PCT No.: PCT/CN2012/081898

§ 371 Date: Oct. 21, 2012

(30) Foreign Application Priority Data
Sep. 19, 2012 (CN) 201210349262.X

(51) Int. Cl. G09G 3/36; G09G 5/10

(52) U.S. Cl. 345/690; 345/87

(57) ABSTRACT

An array substrate includes a plurality of data lines arranged along a row direction to input data signal, a plurality of scanning lines arranged along a column direction to input scanning signals, and a plurality of pixels. Each of the pixels includes a first sub-pixel, a second sub-pixel, a third sub-pixel, and a fourth sub-pixel horizontally arranged along the data lines in turn. And each of the sub-pixels respectively connects to one data lines and one scanning lines. When entering a 3D display mode, the data lines cooperatively operates with the scanning lines so that one of the sub-pixels displays a black image to form an equivalent black matrix. A liquid crystal device including the array substrate is also disclosed. The above array substrate and the liquid crystal device may satisfy the view angle requirement and reduce the crosstalk between two eyes.

### BACKGROUND OF THE INVENTION

1. Field of the Invention

Embodiments of the present disclosure relate to display technology, and more particularly to an array substrate and a liquid crystal display.

2. Discussion of the Related Art

As shown in FIG. 1, a pixel 10 includes three R, G, and B sub-pixels in Tri-gate devices. Scanning lines 11 and data lines 12 are respectively arranged in rows and columns. The R, G, B sub-pixels are arranged along the data lines 12 one by one so that the number of the scanning lines 11 is equal to a vertical resolution, and the number of the data lines 12 is equal to a horizontal resolution. By adopting such pixel structure, the number of the source COF may be reduced. However, an aperture ratio and a transmission rate of the liquid crystal displays are reduced.

FPR (Film-type Patterned Retarder) is one of imaging methods of the conventional 3D liquid display. As shown in FIG. 2, the FPR 3D display system includes a display panel 21, a patterned retarder thin film 22, and a polarized glass 23. The display panel 21 includes a pixel for forming left eye signals 26, a pixel for forming right eye signals 27, and a black matrix (BM) 28 between the above two pixels. FPR 3D display system mainly adopts the patterned retarder thin film 22 on the display panel 21 to divide the 3D image to a left eye image 24 and a right eye image 25. The left eye image 24 and the right eye image 25 are then respectively transmitted to the left eye and the right eye of one viewer by the polarized glass 23. However, the view angle of the FPR 3D display mode is limited. That is, crosstalk may happen when the viewer is viewing the liquid crystal display at a large view angle. For example, as shown in FIG. 2, the signals for the right eye are observed by the left eye at the same time. Thus, the resolution of the images is low. Usually, the solution to resolve the above problems is to increase the width of the BM 28 between two pixels to a certain degree.

As shown in FIG. 3, the width of the BM 33 between the two pixels 31, 32 is increased. As such, the aperture ratio and the transmission rate are further decreased. In addition, though the above problems regarding the view angle and the crosstalk are not existed for 2D display mode, the transmission rate of the 2D display mode is reduced due to the increase of the BM width.

### SUMMARY

The object of the claimed invention is to provide an array substrate and a liquid crystal display for providing a better view angle effect under a 3D display mode. In addition, an aperture ratio and a transmission rate are also enhanced under a 2D display mode.

In one aspect, an array substrate includes a plurality of data lines arranged along a row direction to input data signal, a plurality of scanning lines arranged along a column direction to input scanning signals, and a plurality of pixels. Each of the pixels includes a first sub-pixel, a second sub-pixel, a third sub-pixel, and a fourth sub-pixel horizontally arranged along the data lines in turn. And each of the first sub-pixel, the second sub-pixel, the third sub-pixel, and the fourth sub-pixel respectively connects to one data lines and one scanning lines. Wherein the first sub-pixel, the second sub-pixel, and the third sub-pixel, are respectively a R sub-pixel, a G sub-pixel, and a B sub-pixel, the fourth sub-pixel is a W (white) sub-pixel, when entering a 3D display mode, the data lines cooperatively operate with the scanning lines so that the fourth sub-pixel displays a black image to form an equivalent black matrix.

Wherein the array substrate further includes a plurality of thin film transistors, each of the first sub-pixel, the second sub-pixel, the third sub-pixel, and the fourth sub-pixel respectively connects to one data lines and one scanning lines via one thin film transistors.

In another aspect, an array substrate includes a plurality of data lines arranged along a row direction to input data signal, a plurality of scanning lines arranged along a column direction to input scanning signals, and a plurality of pixels. Each of the pixels includes a first sub-pixel, a second sub-pixel, a third sub-pixel, and a fourth sub-pixel horizontally arranged along the data lines in turn. And each of the first sub-pixel, the second sub-pixel, the third sub-pixel, and the fourth sub-pixel respectively connects to one data lines and one scanning lines. Wherein when entering a 3D display mode, the data lines cooperatively operates with the scanning lines so that the fourth sub-pixel displays a black image to form an equivalent black matrix.

Wherein the first sub-pixel, the second sub-pixel, the third sub-pixel, and the fourth sub-pixel are respectively the R sub-pixel, the G sub-pixel, the B sub-pixel, and the W (white) sub-pixel, and when entering the 3D display mode, the W sub-pixel displays a white image to form the equivalent black matrix.

Wherein the first sub-pixel, the second sub-pixel, the third sub-pixel, and the fourth sub-pixel are respectively the R sub-pixel, the G sub-pixel, the B sub-pixel, and the Y (yellow) sub-pixel, and when entering the 3D display mode, the Y sub-pixel displays a black image to form the equivalent black matrix.

Wherein the array substrate further includes a plurality of thin film transistors, each of the first sub-pixel, the second sub-pixel, the third sub-pixel, and the fourth sub-pixel respectively connects to one data lines and one scanning lines via one thin film transistors.

In another aspect, a liquid crystal display includes an array substrate. The array substrate includes a plurality of data lines arranged along a row direction to input data signal, a plurality of scanning lines arranged along a column direction to input scanning signals, and a plurality of pixels. Each of the pixels includes a first sub-pixel, a second sub-pixel, a third sub-pixel, and a fourth sub-pixel horizontally arranged along the data lines in turn. And each of the first sub-pixel, the second sub-pixel, the third sub-pixel, and the fourth sub-pixel respectively connects to one data lines and one scanning lines. Wherein when entering a 3D display mode, the data lines cooperatively operate with the scanning lines so that the fourth sub-pixel displays a black image to form an equivalent black matrix.

Wherein the first sub-pixel, the second sub-pixel, the third sub-pixel, and the fourth sub-pixel are respectively the R sub-pixel, the G sub-pixel, the B sub-pixel, and the W (white) sub-pixel, and when entering the 3D display mode, the W sub-pixel displays a white image to form the equivalent black matrix.

Wherein the first sub-pixel, the second sub-pixel, the third sub-pixel, and the fourth sub-pixel are respectively the R sub-pixel, the G sub-pixel, the B sub-pixel, and the Y (yellow) sub-pixel, while entering the 3D display mode, the Y sub-pixel displays a black image to form the equivalent black matrix.

Wherein the array substrate further includes a plurality of thin film transistors, each of the first sub-pixel, the second sub-pixel, the third sub-pixel, and the fourth sub-pixel respectively connects to one data lines and one scanning lines via one thin film transistors.

### BRIEF DESCRIPTION OF THE DRAWINGS

FIG. 1 is a planar, schematic view of the pixel of a conventional liquid crystal panel.

FIG. 2 is a schematic view of a conventional FPR 3D display system, wherein the optical path difference is shown.

FIG. 3 is a schematic view of the pixel operating in a 3D display mode while the FPR 3D technology is adopted.

FIG. 4 is a schematic view of the array substrate in accordance with a first embodiment.

FIG. 5 is a display effect diagram showing the pixel of FIG. 4 operating in a 2D display mode and a 3D display mode.

FIG. 6 is a schematic view of the array substrate in accordance with a second embodiment.

FIG. 7 is a display eftect diagram showing the pixel FIG. 6 operating in the 2D display mode and the 3D display mode.

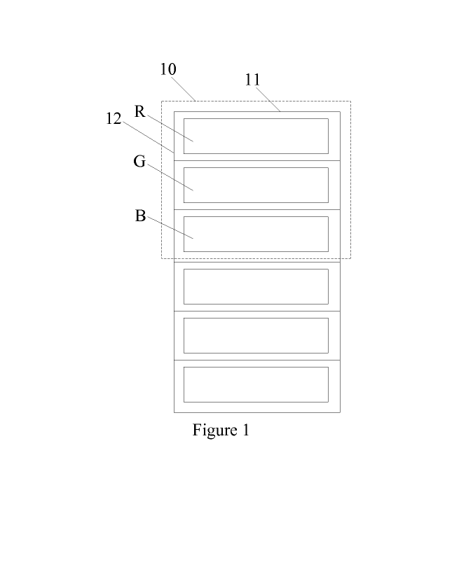

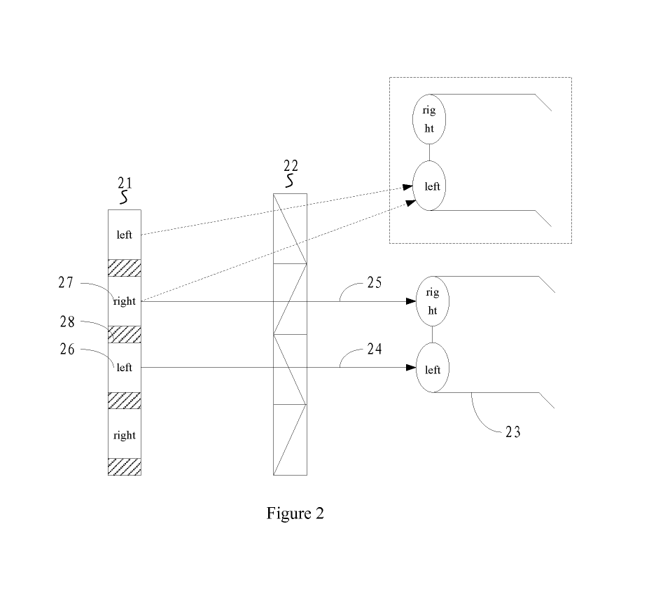

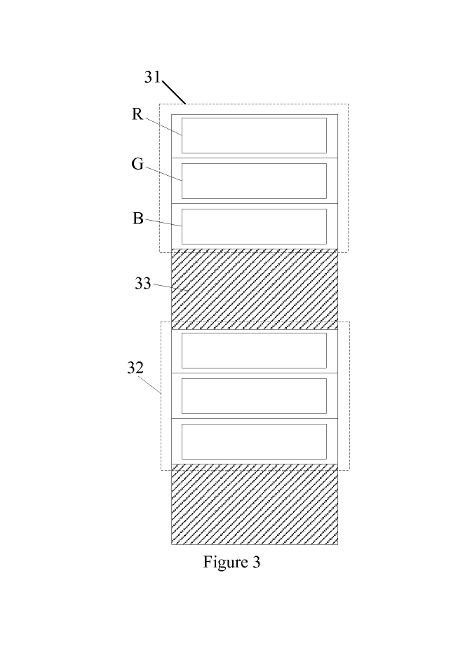

### DETAILED DESCRIPTION OF THE EMBODIMENTS

Embodiments of the invention will now be described more fully hereinafter with reference to the accompanying drawings, in which embodiments of the invention are shown.

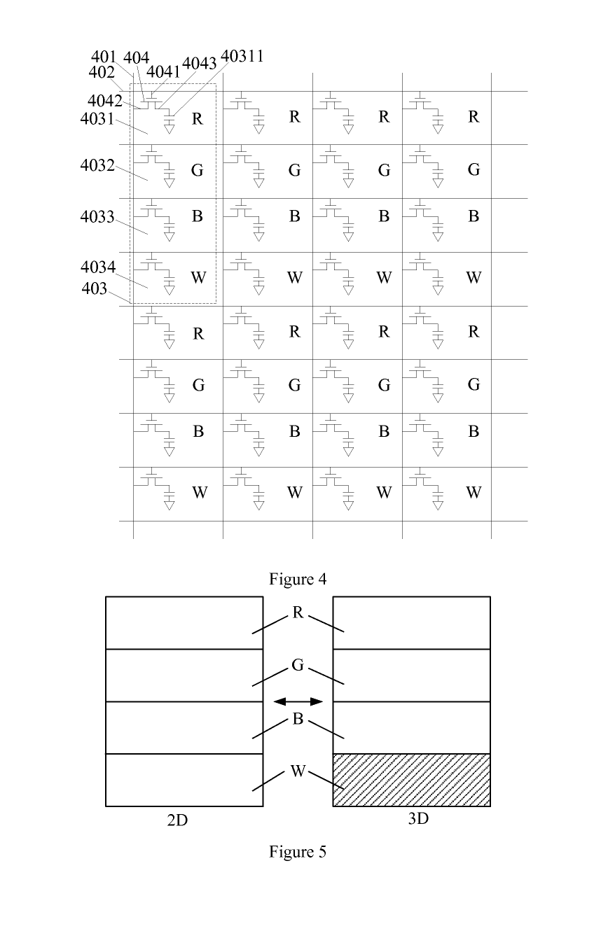

Referring to FIG. 4, in a first embodiment, an array substrate includes a plurality of data lines 401 arranged along a row direction to input data signals, a plurality of scanning lines 402 arranged along a column direction to input scanning signals, a plurality of pixels 403, and a plurality of thin film transistors 404.

Each of the pixels 403 includes a first sub-pixel 4031, a second sub-pixel 4032, a third sub-pixel 4033, and a fourth sub-pixel 4034 horizontally arranged along the data lines 401 in turn. Each of the first sub-pixel 4031, the second sub-pixel 4032, the third sub-pixel 4033, and the fourth sub-pixel 4034 respectively connects to one data lines 401 and one scanning lines 402 via one thin film transistors 404. Each of the first sub-pixel 4031, the second sub-pixel 4032, the third sub-pixel 4033, and the fourth sub-pixel 4034 includes a sub-pixel electrode.

For example, the thin film transistors 404 includes a gate 4041 operating as a control electrode, a source 4042 operating as an input electrode, and a drain 4043 operating as an output electrode. The scanning lines 402 electrically connects with the gate 4041, the data lines 401 electrically connects with the source 4042, and a sub-pixel electrode 40311 of the first sub-pixel 4031 electrically connects with the drain 4043.

When using the liquid crystal device including the above array substrate, each of the scanning lines 402 inputs the scanning signals in turn. The input signals are input to the thin film transistors 404 via the gate 4041 so as to turn on the thin film transistors 404 corresponding to the first sub-pixel 4031, the second sub-pixel 4032, the third sub-pixel 4033, the fourth sub-pixel 4034 one by one. The data lines 401 then input the data signals needed by each sub-pixel to the corresponding pixel electrodes so as to display the images. The data signals are input to the corresponding pixel electrodes by the source 4042 and the drain 4043 of the thin film transistors 404.

When entering a 3D display mode, the data lines 401 cooperatively operate with the scanning lines 402 so that one of the first sub-pixel 4031, the second sub-pixel 4032, the third sub-pixel 4033, the fourth sub-pixel 4034 displays a black image to form an equivalent black matrix between two pixels 403. Specifically, one of the scanning lines 402 input the scanning signals to one of the sub-pixels. The corresponding data lines 401 input the data signal to the sub-pixel so that the sub-pixel display the black image to form the equivalent black matrix.

In the embodiment, the first sub-pixel 4031, the second sub-pixel 4032, the third sub-pixel 4033, and the fourth sub-pixel 4034 are respectively a R sub-pixel, a G sub-pixel, a B sub-pixel and a W (white) sub-pixel. Referring to FIG. 5, under the 3D display mode, the data signals for displaying the black image are input to the W sub-pixel so as to form the equivalent black matrix between two pixels 403. As such, a better view angle may be achieved without increasing materials to form the black matrix between two pixels 403. In addition, the width of the W sub-pixel may be changed along the direction of the data lines 401 so as to satisfy the view angle requirement. When entering a 2D display mode, corresponding white data signals are input to the W sub-pixel to display a white image, not the black image. Thus, the aperture ratio and the transmission rate of the 2D display mode may be enhanced.

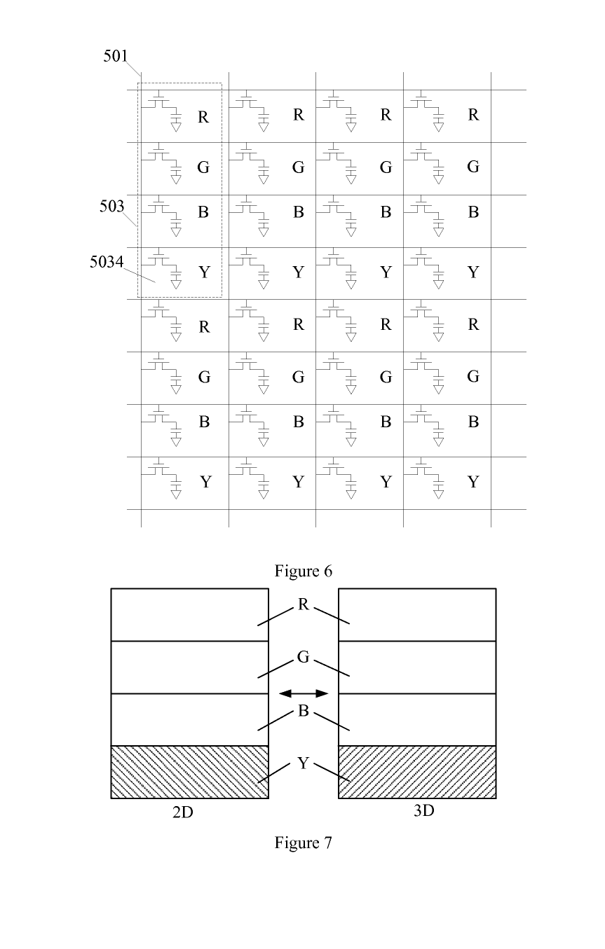

In another embodiment, as shown in FIGS. 6 and 7, a fourth sub-pixel 5034 may be a Y (yellow) sub-pixel. When entering the 3D display mode, the data signals for displaying the black image are input to the Y sub-pixel so as to form the equivalent black matrix between two pixels 403. As such, the view angle requirement is satisfied and the crosstalk between two eyes is reduced. Similarly, the width of the Y sub-pixel may be changed along the direction of the data lines 501 so as to obtain the best view angle. When entering the 2D display mode, corresponding yellow data signals are input to the Y sub-pixel via data lines 501 so that the Y sub-pixel displays a yellow image, not the black image. Thus, the aperture ratio and the transmission rate of the 2D display mode may be enhanced. In addition, as the Y sub-pixel display the yellow image, a cover domain coverage ratio of the 2D display mode may be enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a plurality of data lines arranged along a row direction to input data signal;
a plurality of scanning lines arranged along a column direction to input scanning signals;
a plurality of pixels, each of the pixels comprises a first sub-pixel, a second sub-pixel, a third sub-pixel, and a fourth sub-pixel horizontally arranged along the data lines in turn, and each of the first sub-pixel, the second sub-pixel, the third sub-pixel, and the fourth sub-pixel respectively connects to one data lines and one scanning lines; and
wherein the first sub-pixel, the second sub-pixel, and the third sub-pixel, are respectively a R sub-pixel, a G sub-pixel, and a B sub-pixel, the fourth sub-pixel is a W (white) sub-pixel, when entering a 3D display mode, the data lines cooperatively operate with the scanning lines so that the fourth sub-pixel displays a black image to form an equivalent black matrix.

2. The array substrate as claimed in claim 1, wherein the array substrate further comprises a plurality of thin film transistors, each of the first sub-pixel, the second sub-pixel, the third sub-pixel, and the fourth sub-pixel respectively connects to one data lines and one scanning lines via one thin film transistors.

3. An array substrate, comprising:
a plurality of data lines arranged along a row direction to input data signal;
a plurality of scanning lines arranged along a column direction to input scanning signals;
a plurality of pixels, each of the pixels comprises a first sub-pixel, a second sub-pixel, a third sub-pixel, and a fourth sub-pixel horizontally arranged along the data lines in turn, and each of the first sub-pixel, the second sub-pixel, the third sub-pixel, and the fourth sub-pixel respectively connects to one data lines and one scanning lines; and
wherein when entering a 3D display mode, the data lines cooperatively operates with the scanning lines so that the fourth sub-pixel displays a black image to form an equivalent black matrix.

4. The array substrate as claimed in claim 3, wherein the first sub-pixel, the second sub-pixel, the third sub-pixel, and the fourth sub-pixel are respectively the R sub-pixel, the G sub-pixel, the B sub-pixel, and the W (white) sub-pixel, and when entering the 3D display mode, the W sub-pixel displays a white image to form the equivalent black matrix.

5. The array substrate as claimed in claim 3, wherein the first sub-pixel, the second sub-pixel, the third sub-pixel, and the fourth sub-pixel are respectively the R sub-pixel, the G sub-pixel, the B sub-pixel, and the Y (yellow) sub-pixel, and when entering the 3D display mode, the Y sub-pixel displays a black image to form the equivalent black matrix.

6. The array substrate as claimed in claim 3, wherein the array substrate further comprises a plurality of thin film transistors, each of the first sub-pixel, the second sub-pixel, the third sub-pixel, and the fourth sub-pixel respectively connects to one data lines and one scanning lines via one thin film transistors.

7. A liquid crystal display, comprising:
an array substrate comprises a plurality of data lines arranged along a row direction to input data signal, a plurality of scanning lines arranged along a column direction to input scanning signals, and a plurality of pixels, each of the pixels comprises a first sub-pixel, a second sub-pixel, a third sub-pixel, and a fourth sub-pixel horizontally arranged along the data lines in turn, and each of the first sub-pixel, the second sub-pixel, the third sub-pixel, and the fourth sub-pixel respectively connects to one data lines and one scanning lines; and
wherein when entering a 3D display mode, the data lines cooperatively operate with the scanning lines so that the fourth sub-pixel displays a black image to form an equivalent black matrix.

8. The liquid crystal display as claimed in claim 7, wherein the first sub-pixel, the second sub-pixel, the third sub-pixel, and the fourth sub-pixel are respectively the R sub-pixel, the G sub-pixel, the B sub-pixel, and the W (white) sub-pixel, and when entering the 3D display mode, the W sub-pixel displays a white image to form the equivalent black matrix.

9. The liquid crystal display as claimed in claim 7, wherein the first sub-pixel, the second sub-pixel, the third sub-pixel, and the fourth sub-pixel are respectively the R sub-pixel, the G sub-pixel, the B sub-pixel, and the Y (yellow) sub-pixel, while entering the 3D display mode, the Y sub-pixel displays a black image to form the equivalent black matrix.

10. The liquid crystal display as claimed in claim 10, wherein the array substrate further comprises a plurality of thin film transistors, each of the first sub-pixel, the second sub-pixel, the third sub-pixel, and the fourth sub-pixel respectively connects to one data lines and one scanning lines via one thin film transistors.
